(19) United States
(12) Patent Application Publication
(10) Pub. No.: US 2006/0176804 A1
(43) Pub. Date: Aug. 10, 2006

(54) Data transfer apparatus and multicast system

(75) Inventor: Takeshi Shibata, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/205,170

(22) Filed: Aug. 17, 2005

(30) Foreign Application Priority Data
Feb. 4, 2005 (JP) 2005-028373

(51) Int. Cl. G01R 31/08; H04J 3/26

(52) U.S. Cl. 370/217; 370/432

(57) ABSTRACT

By transmitting/receiving a multicast receiving terminal management message, a router to be a starting point upon creation of a multicast route is determined based on a multicast routing protocol, and switched according to a state of a multicast transmitting terminal side network. Accordingly, when a trouble occurs in the transmitting terminal side network, it becomes possible to perform switching into a redundant network.

### INCORPORATION BY REFERENCE

The present application claims priority from Japanese application JP2005-028373 filed on Feb. 4, 2005, the content of which is hereby incorporated by reference into this application.

### BACKGROUND OF THE INVENTION

The present invention relates to a multicast network, and more particularly to a technique of controlling a multicast relay route.

Multicast is a technique of allowing data transmitted one time to be received by plural terminals (hereinafter, a terminal for transmitting multicast data is referred to as a “multicast transmitting terminal”, a terminal for receiving multicast data is referred to as a “multicast receiving terminal”, and a router for transferring the multicast data is referred to as a “multicast router”). Used for routing the multicast data are one protocol between a multicast receiving terminal and a multicast router and another different protocol between a multicast router and a multicast router.

Protocols called IGMP and MLD (hereinafter, for describing matters common to both IGMP and MLD, referred to collectively as “IGMP/MLD”) are used in IPv4 and in IPv6, respectively, between a multicast receiving terminal and a multicast router, in order to manage a multicast receiving terminal neighboring a multicast router. A protocol called PIM is used between a multicast router and a multicast router in order to perform routing within a multicast network.

In IGMP/MLD, a representative router called Querier (hereinafter, referred to as a “QRY”) exists in each link. A QRY transmits an IGMP/MLD control message to query whether or not a multicast receiving terminal exists within a link to which the QRY belongs.

If multiple multicast routers exist in the same link, those multicast routers exchange an IGMP/MLD control message to thereby determine a single QRY in each link.

With PIM, a representative router called a designated router (DR) exists in each router. PIM-based multicast routing is performed initially by a multicast router serving as a DR among multicast routers that have received a request to receive multicast data based on IGMP/MLD.

If multiple multicast routers exist in the same link, those multicast routers exchange a PIM control message to thereby determine a single DR in each link.

In general, multicast routers have both protocols, IGMP/MLD and PIM, effected in their interfaces in order to handle a change in the topology of a multicast router network, that is, a change in the relationship of how routers, terminals, and the like are connected to one another within a network.

However, the influential range of IGMP/MLD is from a multicast receiving terminal to a neighboring multicast router, while the influential range of PIM is the entirety of a multicast network. If a terminal or a server operated by a malicious user is connected to the multicast network from a neighboring location, it is possible for the user to easily cause confusion in the control of the multicast network based on PIM. Accordingly, in terms of security, particular care must be paid upon handling PIM.

Conventional countermeasures for avoiding the above-mentioned problem with security are broadly divided into two techniques.

One is called IGMP/MLD proxy (see IGMP/MLD-based Multicast Forwarding (“IGMP/MLD proxying”): draft-ietf-magma-igmp-proxy-06.txt).

With the IGMP/MLD proxy, an IGMP/MLD proxy router is introduced between a multicast receiving terminal and a multicast router to cut a PIM-based connection between the multicast router and the multicast receiving terminal. To be specific, the IGMP/MLD proxy integrates requests to receive multicast data based on IGMP/MLD issued from a multicast receiving terminal and transmits the requests to a multicast router, whereby data exchange based on the protocol PIM are performed only between a multicast router and an IGMP/MLD proxy router to prevent a multicast receiving terminal from being involved in the data exchange based on the protocol PIM. Therefore, it is possible to avoid the above-mentioned problem with security.

The other technique is called “passive PIM” (see PIM-SM Multicast Routing Security Issues and Enhancements: draft-ietf-mboned-mroutesec-04.txt), which is now being discussed by the IETF MBONED WG.

With the passive PIM, transmission/reception of a PIM control message is stopped at an interface of a multicast router neighboring a multicast receiving terminal, thereby cutting the PIM-based connection between the multicast router and the multicast receiving terminal. As a result, it is possible to avoid the above-mentioned problem with security.

### SUMMARY OF THE INVENTION

For an actual operation, a network is often arranged to have a topology including redundant routes to enhance reliability. The reason that the redundant routing increases the reliability is because a certain route, in which a failure has occurred, can be switched into another route.

In the case where redundancy is provided between a multicast receiving terminal and a multicast router in a network arrangement having an IGMP/MLD proxy router introduced between the multicast receiving terminal and the multicast router, when every IGMP/MLD proxy router made redundant transfers to the multicast router a request to receive multicast data issued from the multicast receiving terminal, multiple multicast distribution routes are created between the multicast receiving terminal and the multicast router, and multicast data is transmitted to the multicast receiving terminal duplicatedly. Therefore, it is determined that only the IGMP/MLD proxy router serving as a QRY can transfer to the multicast router the request to receive multicast data issued from the multicast receiving terminal.

Herein, it is assumed that a failure occurs between the IGMP/MLD proxy router serving as a QRY and the IGMP/MLD proxy router. In this case, it is desirable that the multicast distribution route be switched into a redundant route. However, the QRY is determined only based on exchange of an IGMP/MLD control message, so that the QRY is not switched into another redundant IGMP/MLD proxy router. Accordingly, the multicast distribution route is not switched into a redundant route.

Described hereinabove is Problem 1 to be solved by the present invention.

When redundancy is provided to a multicast router neighboring a multicast receiving terminal, and when an interface of the multicast router neighboring the multicast receiving terminal operates based on passive PIM, the transmission/reception of a PIM control message is not performed in a link between the multicast receiving terminal and the multicast router, so that all multicast routers operate as DRs. Therefore, multiple multicast distribution routes are created, and multicast data is transmitted to the multicast receiving terminal duplicatedly. However, IGMP/MLD is used also in a passive PIM-based interface in order to manage multicast receiving terminals, and one QRY is determined in each link.

Described hereinabove is Problem 2 to be solved by the present invention.

As a measure for solving Problem 1, according to the present invention, in the case where a failure has occurred in one of multicast distribution routes made redundant between an IGMP/MLD proxy router and a multicast router, a QRY function of the IGMP/MLD proxy router on a side of the distribution route, in which the failure has occurred, is nullified to stop transmission of an IGMP/MLD control message. Alternatively, the IGMP/MLD proxy router has its priority as a QRY candidate made lower than that of another IGMP/MLD proxy router. Accordingly, the QRY is switched into another IGMP/MLD proxy router made redundant, so the multicast distribution route is switched into a redundant route in which no failure has occurred, thereby solving Problem 1.

As a measure for solving Problem 2, according to the present invention, only the one having a passive PIM interface and being a QRY becomes a DR. Thus, one DR is determined in each link.

Although one DR is determined in each link on condition that only the one having a passive PIM interface and being a QRY becomes a DR, this leads to a problem similar to Problem 1.

Therefore, in the case where a failure has occurred in one of multicast distribution routes made redundant between a passive PIM multicast router and a multicast router, a QRY function of the passive PIM multicast router on a side of the distribution route, in which the failure has occurred, is nullified to stop transmission of an IGMP/MLD control message. Alternatively, the passive PIM multicast router has its priority as a QRY candidate made lower than that of another passive PIM multicast router.

Accordingly, since one DR is determined in each link, duplicated transmission of multicast data is avoided. In addition, upon the occurrence of routing failure, the DR as well as the QRY is switched into another passive PIM multicast router made redundant, so the multicast distribution route is switched into a redundant route, thereby solving Problem 2.

Similar mechanism to the measure for solving Problem 1 is also effective in a multicast router that operates with IGMP/MLD and PIM effected simultaneously. In redundant topology, a single DR that serves as a starting point is determined in each link through exchange a PIM control message. However, even in the case where a failure has occurred in a route on a DR side between a multicast router and a multicast transmitting terminal, the DR is not changed in general, and a PIM control message is transmitted to a data transfer apparatus through a link between the multicast router and a multicast receiving terminal, which creates a multicast distribution route that extends passing through the data transfer apparatus made redundant. In this case, if the DR is switched, an unnecessary PIM control message is transmitted to the above link.

Therefore, in the case where a failure has occurred in a route on the multicast transmitting terminal side rather than the multicast router side, when the DR function is nullified to stop the transmission of the control message, or when the priority as the DR candidate is lowered, a multicast router on the side of redundant topology, in which no failure has occurred, is switched into a DR, and a multicast distribution route is effectively created without having the control message transmitted to a link between a multicast router and a multicast receiving terminal in a distribution route in which a failure has occurred.

Further, a similar effect is also produced by applying the above-mentioned measure to a case where a multicast router neighboring the multicast transmitting terminal transmits a PIM control message obtained by encapsulating multicast data to a core router called a rendezvous point (RP).

According to the present invention, among redundant multicast distribution routes which are arranged using an IGMP/MLD proxy router operating with no PIM effected in terms of security, even if a failure occurs in a certain distribution route, the distribution route can be switched by nullifying the IGMP/MLD-based QRY function to stop the transmission of the QRY control message or by lowering a priority as the QRY candidate. Accordingly, a multicast packet can be transmitted to the multicast receiving terminal.

Further, even among redundant multicast distribution routes which are arranged using a passive PIM router providing a limited operation based on PIM in terms of security to be made redundant, it is possible to avoid the multicast receiving terminal from receiving a multicast packet duplicatedly by determining only the one serving as a QR to be a DR.

Further, even in the case where a failure has occurred in a multicast distribution route made redundant based on passive PIM, the distribution route can be switched by nullifying the IGMP/MLD-based QRY function to stop the transmission of the QRY control message or by lowering a priority as the QRY candidate. Accordingly, a multicast packet can be transferred to the multicast receiving terminal.

Further, even in the case where a failure has occurred in a multicast distribution route made redundant based on PIM, the distribution route can be switched by nullifying the PIM-based DR function to stop the transmission of the DR control message or by lowering a priority as the DR candidate. Accordingly, a multicast packet can be transferred to the multicast receiving terminal.

Other objects, features and advantages of the invention will become apparent from the following description of the embodiments of the invention taken in conjunction with the accompanying drawings.

### BRIEF DESCRIPTION OF THE DRAWINGS

FIG. 1 is a network diagram to which the present invention is applied;

FIG. 2 is a diagram showing an apparatus in embodiments of the present invention;

FIG. 3 is a sequence diagram of processings according to Embodiment 1 of the present invention;

FIG. 4 is a processing flowchart of processings according to Embodiment 1 of the present invention;

FIG. 5 is a sequence diagram of processings according to Embodiment 2 of the present invention;

FIG. 6 is a processing flowchart according to Embodiment 2 of the present invention;

FIG. 7 is a sequence diagram of processings according to Embodiment 3 of the present invention;

FIG. 8 is a processing flowchart of processings according to Embodiment 3 of the present invention;

FIG. 9 is a sequence diagram of processings according to Embodiment 4 of the present invention; and

FIG. 10 is a processing flowchart of processings according to Embodiment 4 of the present invention.

### DESCRIPTION OF THE EMBODIMENTS

### Embodiment 1

Hereinafter, an IGMP/MLD proxy router according to an embodiment of the present invention is described.

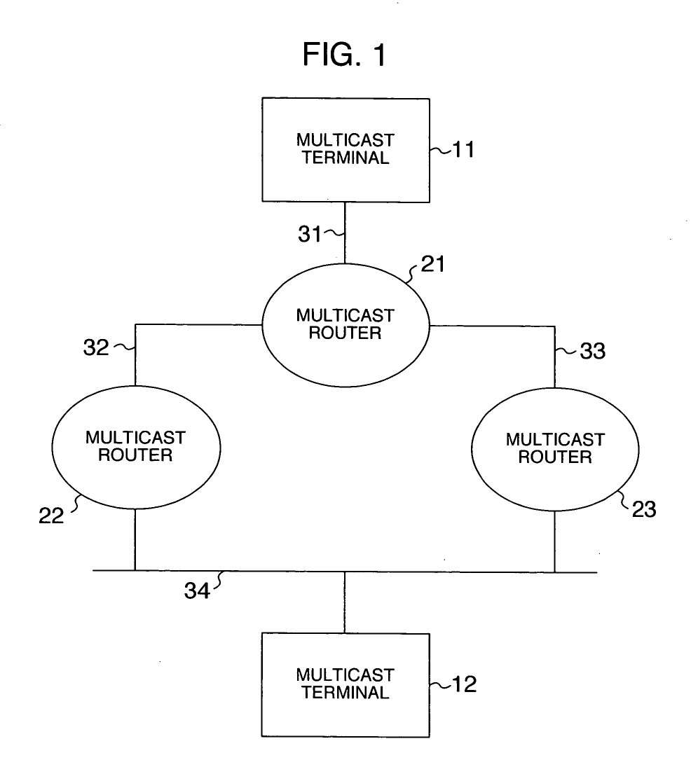

Referring to the schematic diagram of FIG. 1, the network arrangement is described. In FIG. 1, a multicast terminal 11 is a multicast transmitting terminal as a transmission source of multicast data, a multicast terminal 12 is a multicast receiving terminal for receiving the multicast data, a multicast router 21 transfers the multicast data, and multicast routers 22 and 23 are IGMP/MLD proxy routers for transferring a request to receive multicast data in IGMP/MLD, from the multicast receiving terminal 12 to the multicast router 21.

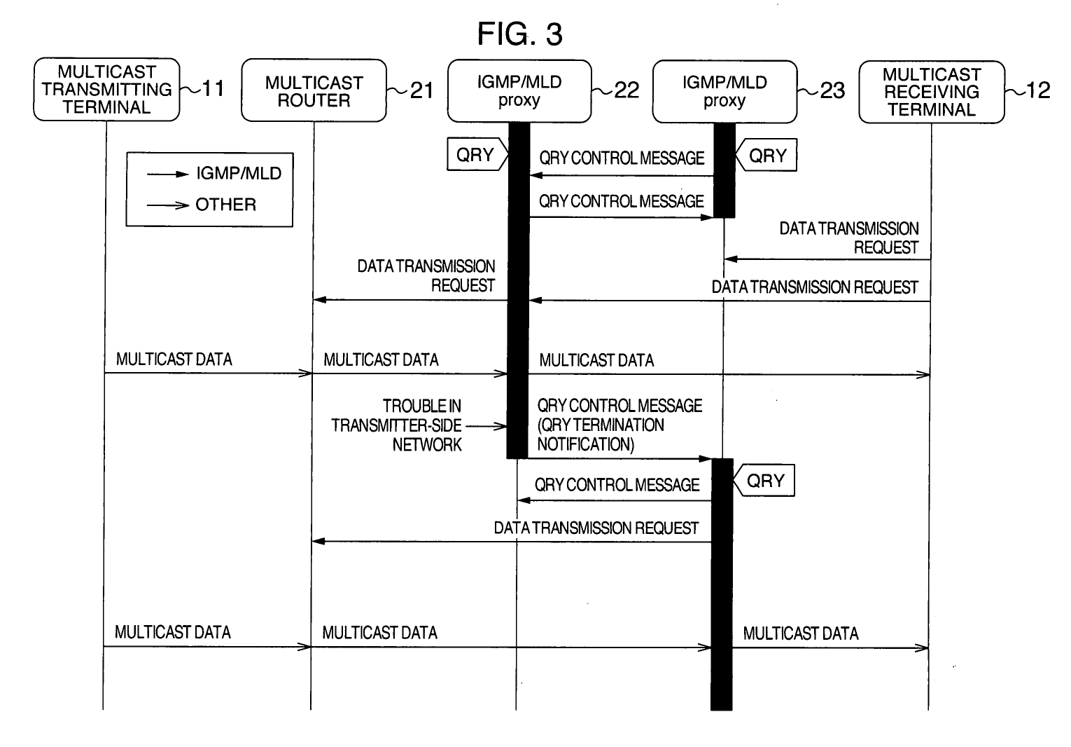

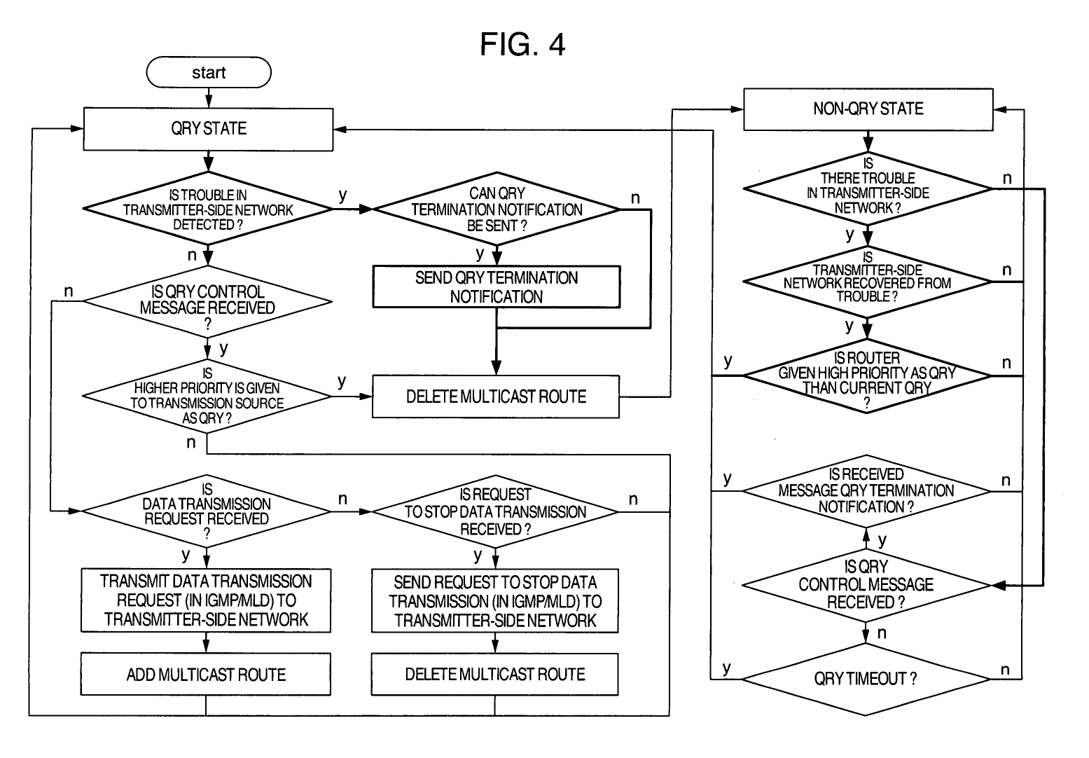

Referring to a sequence diagram of FIG. 3 and a processing flowchart of FIG. 4, an operation of the present invention is described.

The IGMP/MLD proxy routers 22 and 23 mutually send/receive a control message for determining a QRY of the IGMP/MLD on a link 34 of FIG. 1, through the link 34, and a priority of a router as the QRY is determined based on the length (value) of the transmission source address of the QRY control message. It is assumed that the IGMP/MLD proxy router 22 is selected as the QRY on the link 34 as a result thereof.

A request to transmit multicast data in IGMP/MLD, which is sent from the multicast receiving terminal 12 to the link 34, is transferred to the multicast router 21 by the IGMP/MLD proxy router 22 as the QRY out of the IGMP/MLD proxy routers 22 and 23 receiving the request to transmit the multicast data.

Through the above processing, a multicast distribution route from the multicast router 21 to the multicast receiving terminal 12, which passes the IGMP/MLD proxy router 22, is set, and the multicast data sent from the multicast transmitting terminal 11 is transmitted to the multicast receiving terminal 12.

Suppose that any trouble has occurred in the transmission side network of the IGMP/MLD proxy router 22.

Any possible troubles include a failure in line of the link 32 of FIG. 1, a failure in unicast route control processing between the multicast router 21 to the IGMP/MLD proxy router 22, and a failure in multicast route control processing, which are detected as an electric trouble, a trouble in unicast route control, and a trouble in multicast route control, in the IGMP/MLD proxy router 22.

When any trouble is detected in the transmission side network, the IGMP/MLD proxy router 22 sends a QRY termination notification to the link 34 of FIG. 1, if the QRY termination notification can be sent as in the IGMP Version3 and MLD Version2, and otherwise, does not send such a QRY termination notification and enters a non-QRY state. Alternatively, the router may send a QRY control message including information to the effect that its priority as the QRY candidate is lowered.

In response to the reception of the QRY termination notification from the IGMP/MLD router 22, the timeout of the QRY control, or the reception of the information to the effect that the priority as the QRY candidate is lowered, the IGMP/MLD proxy router 23 detects that the IGMP/MLD proxy router 22 is no longer the QRY, and shifts to the QRY state to send a request to transmit the multicast data from the multicast receiving terminal 12, to the multicast router 21.

Through the above processing, even when any failure occurs in a distribution route based on the IGMP/MLD proxy of the redundant topology, the multicast distribution route from the multicast router 21 to the multicast receiving terminal 12 is switched to the multicast distribution route passing the IGMP/MLD proxy router 23, and the multicast data sent from the multicast transmitting terminal 11 is transmitted to the multicast receiving terminal 12.

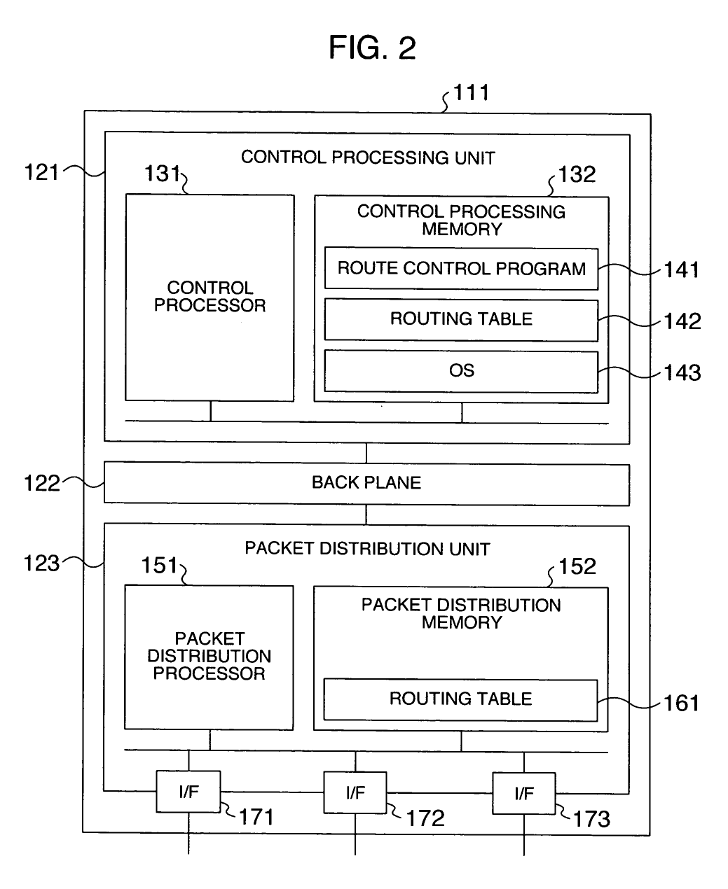

Referring to FIG. 2, the hardware configuration of the IGMP/MLD proxy router of this embodiment is described.

The IGMP/MLD proxy router of this embodiment is configured by a control processing unit 121 for IGMP/MLD protocol processing, a packet distribution unit 123 for transmitting/receiving packets, and a back plane 122 connecting between the control processing unit 121 and the packet distribution unit 123.

The control processing unit 121 includes a control processing memory 132 storing at least a route control program 141, a routing table 142, and an OS (operating system) 143, and a control processor 131 for executing the route control program 141 and the OS 143.

The packet distribution unit 123 includes a packet distribution memory 152 storing at least a routing table 161, a packet distribution processor 151 for executing a packet distribution processing, and multiple I/Fs (interfaces) 171, 172, 173, . . . .

The control processing memory 132 stores the IGMP/MLD proxy router program for executing processings of FIG. 4, as one of the route control programs 141. The IGMP/MLD packets received by the I/Fs 171, 172, 173, . . . are sent to the control processing unit 121 by way of the back plane 122, and the processings of FIG. 4 are carried out based on the IGMP/MLD proxy router program. The IGMP/MLD proxy router program executes creation/deletion of the multicast route in/from the routing table 142 in the control processing unit 121 as necessary. Multicast route information in the routing table 142 in the control processing unit 121 are transferred to the packet distribution unit 123 and stored in the routing table 161. The multicast packets received by the I/Fs 171, 172, 173, . . . are transferred by the packet forwarding processor 151 in accordance with the multicast route information in the routing table 161.

### Embodiment 2

A passive PIM multicast router according to an embodiment of the present invention is described.

Referring to a schematic diagram of FIG. 1, the network arrangement is described. In FIG. 1, the multicast terminal 11 is a multicast transmitting terminal as a transmission source of multicast data, the multicast terminal 12 is a multicast receiving terminal for receiving the multicast data, the multicast router 21 distributes the multicast data, and the multicast routers 22 and 23 are passive PIM multicast routers receiving a request to receive multicast data in IGMP/MLD, from the multicast receiving terminal 12, and sending a request to receive multicast data in PIM, to the multicast router 21.

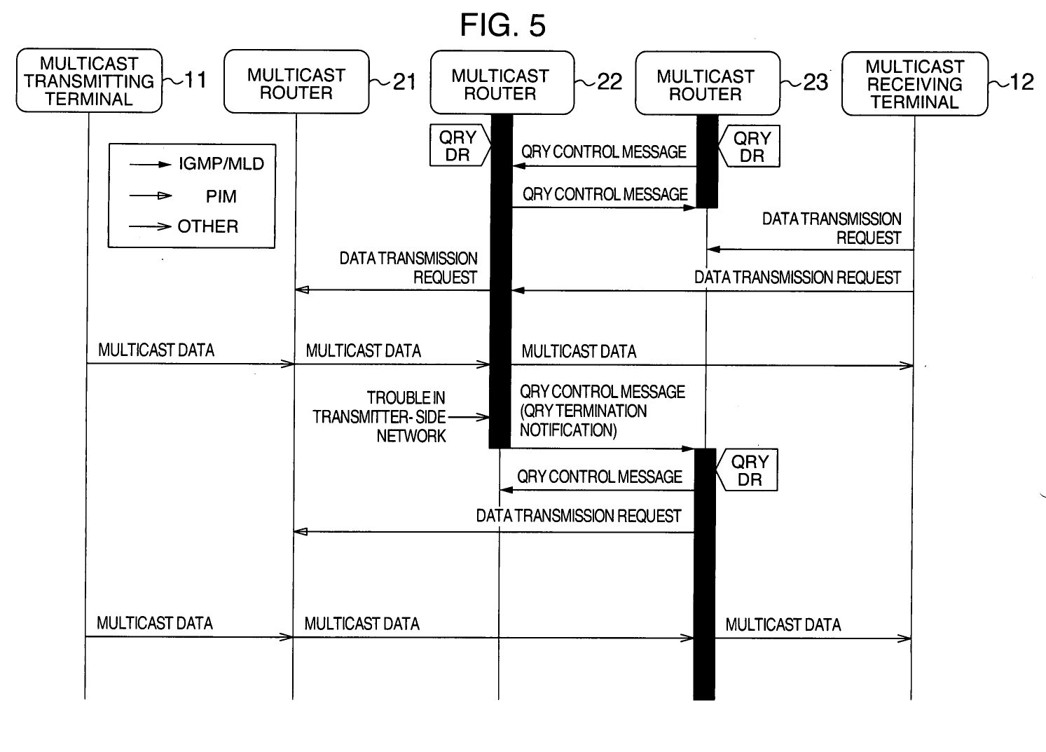

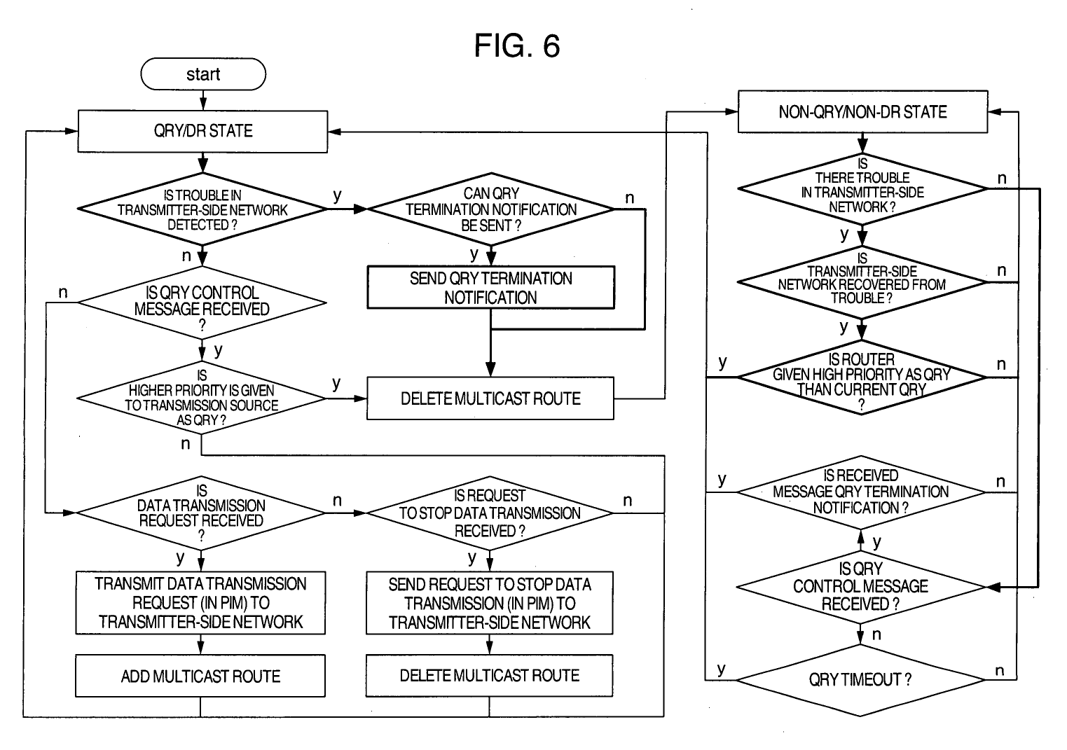

Referring to a sequence diagram of FIG. 5 and a processing flowchart of FIG. 6, an operation of the present invention is described.

The passive PIM multicast routers 22 and 23 mutually send/receive a control message for determining a QRY of the IGMP/MLD on the link 34 of FIG. 1, through the link 34, and a priority of a router as the QRY is determined based on the length (value) of the transmission source address of the QRY control message. It is assumed that the passive PIM multicast router 22 is selected as the QRY on the link 34 as a result thereof.

Under such a condition that a router as the QRY of the IGMP/MLD can be a DR in the passive PIM interface, the passive PIM multicast router 22 is selected as the DR on the link 34. Thus, even if the passive PIM is applied to the redundant topology, a single multicast router is determined as the DR to avoid duplicated transmission of data to the multicast receiving terminal.

A request to transmit multicast data in IGMP/MLD, which is sent from the multicast receiver terminal 12 to the link 34 is transferred to the multicast router 21 by the passive PIM multicast router 22 as the DR as well as the QRY out of the passive PIM multicast routers 22 and 23 receiving the request to transmit the multicast data.

Through the above processing, a multicast distribution route from the multicast router 21 to the multicast receiving terminal 12, which passes through the passive PIM multicast router 22 is by no means created duplicatedly to thereby avoid duplicated transmission of the multicast data sent from the multicast transmitting terminal 11 to the multicast receiving terminal 12.

Suppose that any trouble has occurred in the transmission side network of the passive PIM multicast router 22 as the DR, and QRY.

Any possible troubles include a failure in line of the link 32 of FIG. 1, a failure in unicast route control processing between the multicast router 21 to the passive PIM multicast router 22, and a failure in multicast route control processing, which are detected as an electric trouble, a trouble in unicast route control, and a trouble in multicast route control, in the passive PIM multicast router 22.

When any trouble is detected in the transmission side network, the passive PIM multicast router 22 sends a QRY termination notification, if the QRY termination notification can be sent as in the IGMP Version3 and MLD Version2, and otherwise, does not send such a QRY control message and enters a non-DR state as well as a non-QRY state. Alternatively, the router may send a QRY control message including information to the effect that its priority as the QRY candidate is lowered.

In response to the reception of the QRY termination notification from the passive PIM multicast router 22, the timeout of the QRY control, or the reception of the information to the effect that the priority as the QRY candidate is lowered, the passive PIM multicast router 23 detects that the passive PIM multicast router 22 is no longer the QRY, and shifts to the QRY state and DR state to transfer a request to transmit the multicast data from the multicast receiving terminal 12, to the multicast router 21.

Through the above processing, even when any failure occurs in a distribution route based on the passive PIM of the redundant topology, the multicast distribution route from the multicast router 21 to the multicast receiving terminal 12 is switched to the multicast distribution route passing the passive PIM multicast router 23, and the multicast data sent from the multicast transmitting terminal 11 is transmitted to the multicast receiving terminal 12.

Referring to FIG. 2, the hardware configuration of the passive PIM multicast router of this embodiment is described.

The passive PIM multicast router of this embodiment is configured by the control processing unit 121 for IGMP/MLD and PIM protocol processings, the packet distribution unit 123 for sending/receiving packets, and the back plane 122 connecting between the control processing unit 121 and the packet distribution unit 123.

The control processing unit 121 includes the control processing memory 132 storing at least the route control program 141, the routing table 142, and the OS 143, and the control processor 131 for executing the route control program 141 and the OS 143.

The packet distribution unit 123 includes the packet distribution memory 152 storing at least the routing table 161, the packet distribution processor 151 for executing a packet distribution processing, and the multiple I/Fs 171, 172, 173, . . . .

The control processing memory 132 stores the passive PIM multicast router program for executing processings of FIG. 6, as one of the route control programs 141.

The IGMP/MLD packets received by the I/Fs 171, 172, 173, . . . are sent to the control processing unit 121 by way of the back plane 122, and the processings of FIG. 6 are carried out based on the passive PIM multicast router program. The passive PIM multicast router program executes creation/deletion of the multicast route in/from the routing table 142 in the control processing unit 121 as necessary. Multicast route information in the routing table 142 in the control processing unit 121 are distributed to the packet distribution unit 123 and stored in the routing table 161. The multicast packets received by the I/Fs 171, 172, 173, . . . are distributed by the packet distribution processor 151 in accordance with the multicast route information in the routing table 161.

### Embodiment 3

A multicast router according to another embodiment of the present invention is described.

Referring to a schematic diagram of FIG. 1, the network arrangement is described. In FIG. 1, the multicast terminal 11 is a multicast transmitting terminal as a transmission source of multicast data, the multicast terminal 12 is a multicast receiving terminal for receiving the multicast data, the multicast router 21 distributes the multicast data, and the multicast routers 22 and 23 are IGMP/MLD proxy routers for receiving a request to receive multicast data in IGMP/MLD, from the multicast receiving terminal 12 and sending a request to receive multicast data in PIM to the multicast router 21.

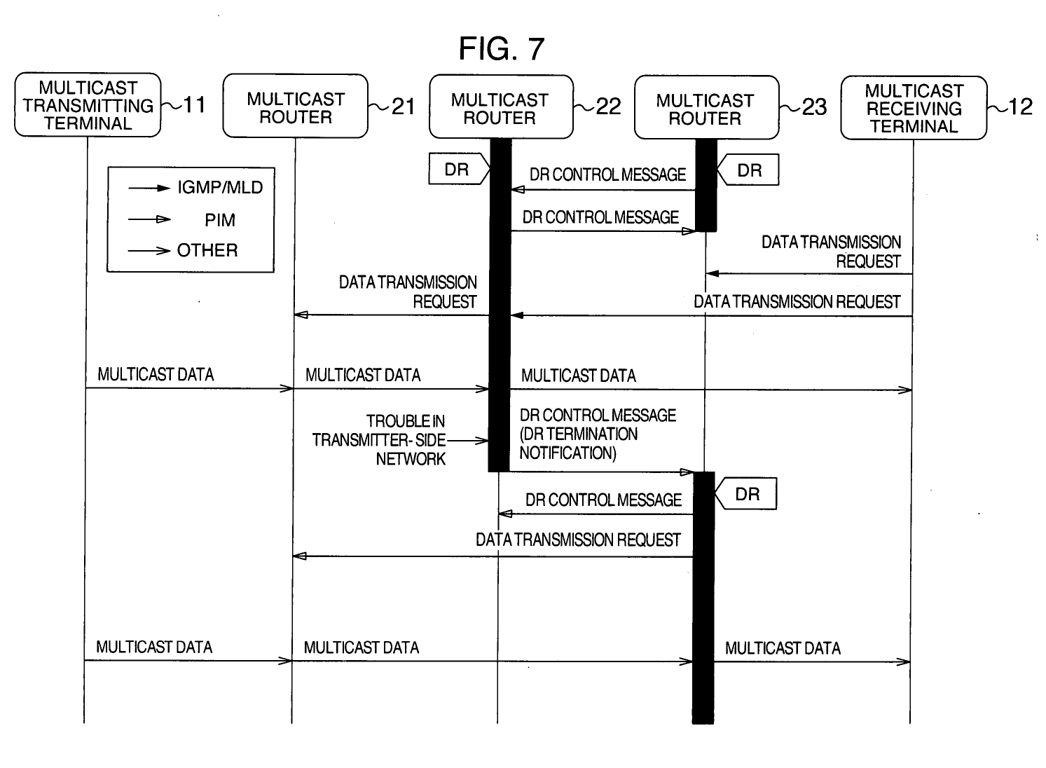

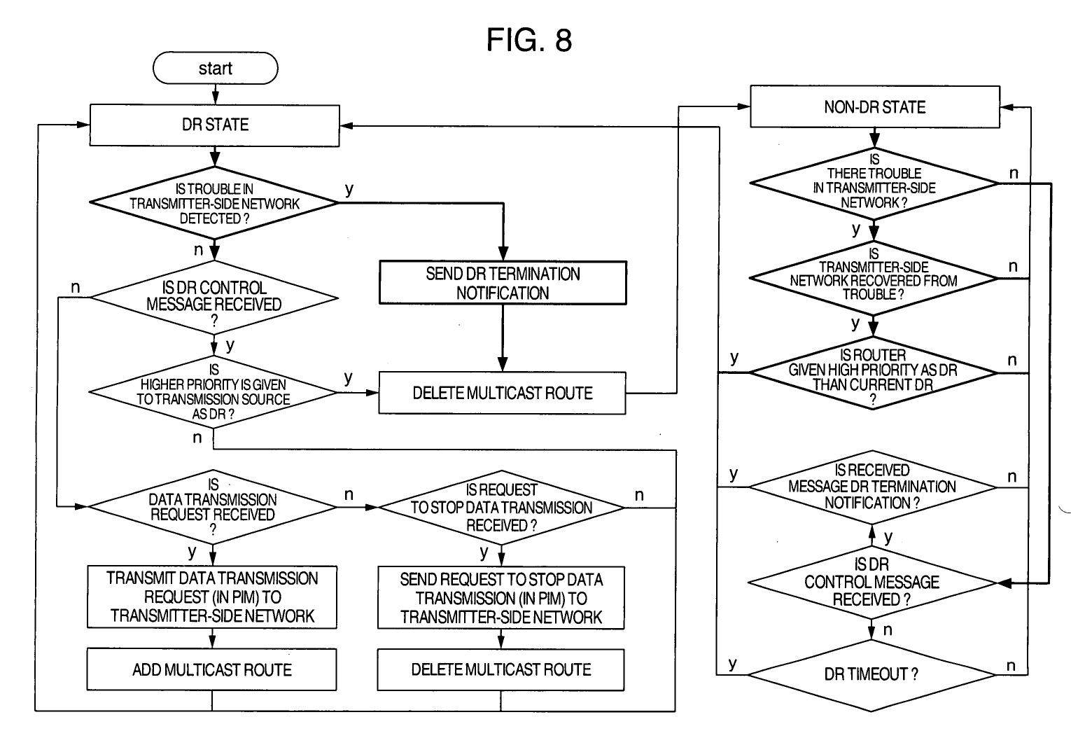

Referring to a sequence diagram of FIG. 7 and a processing flowchart of FIG. 8, an operation of the present invention is described.

The multicast routers 22 and 23 mutually send/receive a control message for determining a DR of the PIM on the link 34 of FIG. 1, through the link 34, and a priority of a router as the DR is determined based on the length (value) of the transmission source address of the DR control message. It is assumed that the multicast router 22 is selected as the DR on the link 34 as a result thereof.

A request to transmit multicast data in IGMP/MLD, which is sent from the multicast receiving terminal 12 to the link 34, is transferred to the multicast router 21 by the multicast router 22 as the DR out of the multicast routers 22 and 23 receiving the request to transmit the multicast data.

Through the above processing, a multicast distribution route from the multicast router 21 to the multicast receiving terminal 12, which passes through the multicast router 22 is set, and the multicast data sent from the multicast transmitting terminal 11 is transferred to the multicast receiving terminal 12.

Suppose that any trouble has occurred in the transmission side network of the multicast router 22.

Any possible troubles include a failure in line of the link 32 of FIG. 1, a failure in unicast route control processing between the multicast router 21 to the multicast router 22, and a failure in multicast route control processing, which are detected as an electric trouble, a trouble in unicast route control, and a trouble in multicast route control, in the multicast router 22.

When any trouble is detected in the transmission side network, the multicast router 22 sends a DR termination notification to the link 34 of FIG. 1, and enters a non-DR state. Alternatively, the router may send a DR control message including information to the effect that its priority as the DR candidate is lowered. In response to the reception of the DR termination notification from the multicast router 22, or the reception of the information to the effect that the priority as the DR candidate is lowered, the multicast router 23 detects that the multicast router 22 is no longer the DR, and shifts to the DR state to transfer a request to transmit the multicast data from the multicast receiving terminal 12, to the multicast router 21.

Through the above processing, even when-any failure occurs in a distribution route based on the PIM of the redundant topology, the multicast distribution route from the multicast router 21 to the multicast receiving terminal 12 is switched to the multicast distribution route passing the multicast router 23, and the multicast data sent from the multicast transmitting terminal 11 is transmitted to the multicast receiving terminal 12.

Referring to FIG. 2, the hardware configuration of the multicast router of this embodiment is described.

The multicast router of this embodiment is configured by the control processing unit 121 for IGMP/MLD and PIM protocol processings, the packet distribution unit 123 for sending/receiving packets, and the back plane 122 connecting between the control processing unit 121 and the packet distribution unit 123.

The control processing unit 121 includes a control processing memory 132 storing at least the route control program 141, the routing table 142, and the OS 143, and the control processor 131 for executing the route control program 141 and the OS 143.

The packet distribution unit 123 includes the packet distribution memory 152 storing at least the routing table 161, the packet distribution processor 151 for executing a packet distribution processing, and the multiple I/Fs 171, 172, 173,

The control processing memory 132 stores the multicast router program for executing processings of FIG. 8, as one of the route control programs 141. The IGMP/MLD packets received by the I/Fs 171, 172, 173, . . . are sent to the control processing unit 121 by way of the back plane 122, and the processings of FIG. 8 are carried out based on the multicast router program. The multicast router program executes creation/deletion of the multicast route in/from the routing table 142 in the control processing unit 121 as necessary. Multicast route information in the routing table 142 in the control processing unit 121 are distributed to the packet distribution unit 123 and stored in the routing table 161. The multicast packets received by the I/Fs 171, 172, 173, . . . are distributed by the packet distribution processor 151 in accordance with the multicast route information in the routing table 161.

### Embodiment 4

A multicast router neighboring a multicast transmitting terminal according to an embodiment of the present invention is described.

Referring to a schematic diagram of FIG. 1, the network arrangement is described. In FIG. 1, the multicast terminal 12 is a multicast transmitting terminal as a transmitting source of multicast data, the multicast terminal 11 is a multicast receiving terminal for receiving the multicast data, the multicast router 21 is a multicast router called an RP, and the multicast routers 22 and 23 receive multicast data from the multicast transmitting terminal 12, and sending a PIM-based control message including the encapsulated multicast data to the multicast router 21 as the RP.

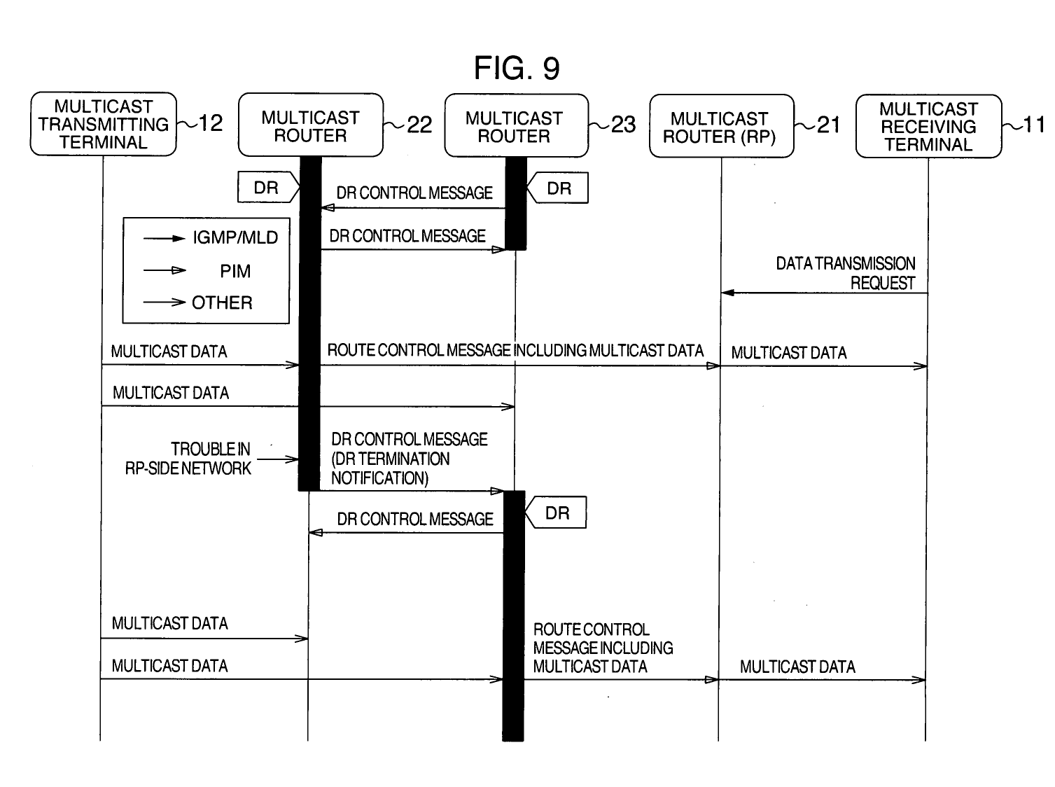

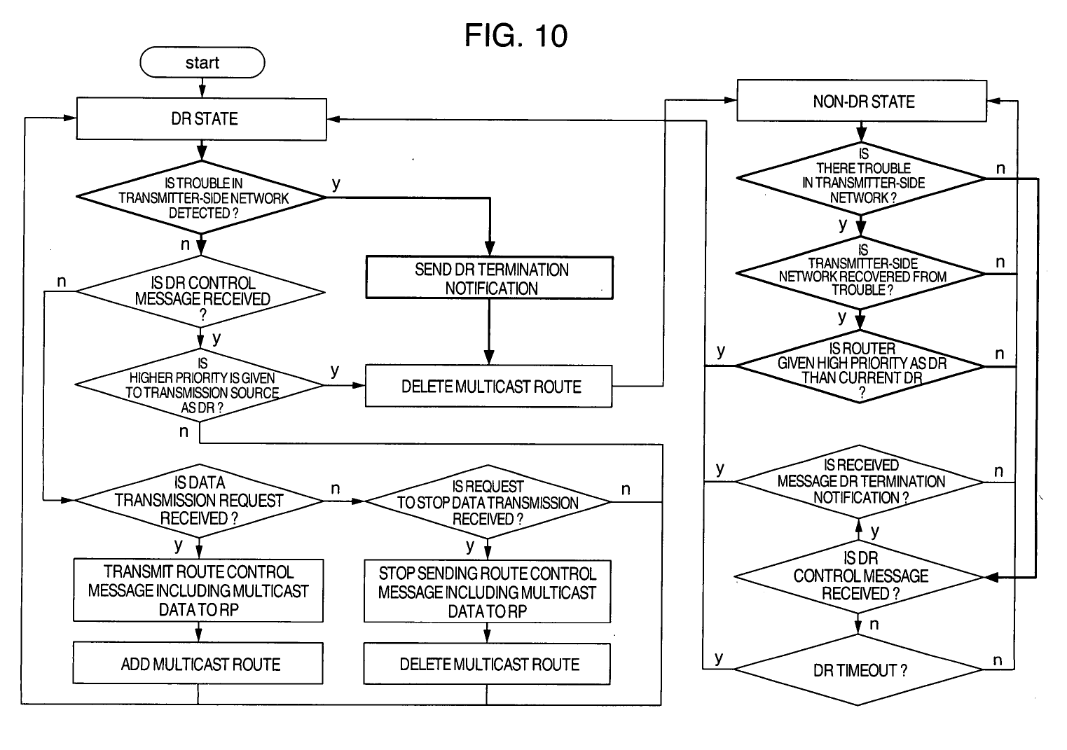

Referring to a sequence diagram of FIG. 9 and a processing flowchart of FIG. 10, an operation of the present invention is described.

The multicast routers 22 and 23 mutually send/receive a control message for determining a DR of the PIM on the link 34 of FIG. 1, through the link 34, and a priority of a router as the DR is determined based on the length (value) of the transmission source address of the DR control message. It is assumed that the multicast router 22 is selected as the DR on the link 34 as a result thereof.

Multicast data sent from the multicast receiving terminal 12 to the link 34, is transmitted as the control message including the encapsulated multicast data to the multicast router 21 as the RP by the multicast router 22 as the DR out of the multicast routers 22 and 23 receiving the data.

Through the above processing, a multicast distribution route from the multicast transmitting terminal 12 to the multicast router 21 as the RP, which passes through the multicast router 22 is set, and the multicast data sent from the multicast transmitting terminal 12 is transmitted to the multicast router 21 as the RP.

Suppose that any trouble has occurred in the RP side network of the multicast router 22.

Any possible troubles include a failure in line of the link 32 of FIG. 1, a failure in unicast route control processing between the multicast router 22 to the multicast router 21 as the RP, and a failure in multicast route control processing, which are detected as an electric trouble, a trouble in unicast route control, and a trouble in multicast route control, in the multicast router 22.

When any trouble is detected in the transmission side network, the multicast router 22 sends a DR termination notification to the link 34 of FIG. 1, and enters a non-DR state. Alternatively, the router may send a DR control message including information to the effect that its priority as the DR candidate is lowered.

In response to the reception of the DR termination notification from the multicast router 22, or the reception of the information to the effect that the priority as the DR candidate is lowered, the multicast router 23 detects that the multicast router 22 is no longer the DR, and shifts to the DR state to transfer a PIM-based control message including the encapsulated multicast data, which is sent from the multicast transmitting terminal 12, to the multicast router 21 as the RP.

Through the above processing, even when any failure occurs in a distribution route based on the RP of the redundant topology, the multicast distribution route from the multicast transmitting terminal 12 to the multicast router 21 as the RP is switched to the multicast distribution route passing the multicast router 23, and the multicast data sent from the multicast transmitting terminal 12 is transmitted to the multicast router 21 as the RP.

Referring to FIG. 2, the hardware configuration of the multicast router of this embodiment is described.

The multicast router of this embodiment is configured by the control processing unit 121 for PIM protocol processing, the packet distribution unit 123 for sending/receiving packets, and the back plane 122 connecting between the control processing unit 121 and the packet distribution unit 123.

The control processing unit 121 includes the control processing memory 132 storing at least the route control program 141, the routing table 142, and the OS 143, and the control processor 131 for executing the route control program 141 and the OS 143.

The packet distribution unit 123 includes the packet distribution memory 152 storing at least the routing table 161, the packet distribution processor 151 for executing a packet distribution processing, and the multiple I/Fs 171, 172, 173, . . . .

The control processing memory 132 stores the multicast router program for executing processings of FIG. 10, as one of the route control programs 141. The multicast packets received by the I/Fs 171, 172, 173, . . . are sent to the control processing unit 121 by way of the back plane 122, and the processings of FIG. 10 are carried out based on the multicast router program. The multicast router program executes creation/deletion of the multicast route in/from the routing table 142 in the control processing unit 121 as necessary. Multicast route information in the routing table 142 in the control processing unit 121 are distributed to the packet distribution unit 123 and stored in the routing table 161. The multicast packets received by the I/Fs 171, 172, 173, . . . are distributed by the packet distribution processor 151 in accordance with the multicast route information in the routing table 161.

It should be further understood by those skilled in the art that although the foregoing description has been made on embodiments of the invention, the invention is not limited thereto and various changes and modifications may be made without departing from the spirit of the invention and the scope of the appended claims.

1. A data transfer apparatus, capable of transferring multicast data, which is connected to a terminal for transmitting multicast data, a terminal for receiving multicast data, and another data transfer apparatus forming redundant topology with the data transfer apparatus, comprising:
an interface for transmitting/receiving data; and
a transfer processing unit for performing a transfer processing on data received from the interface,
wherein, when a trouble occurs in a network between the terminal for transmitting multicast data and the interface or a network between the terminal for receiving multicast data and the interface, a distribution route for multicast data is switched into a route passing the another multicast data transfer apparatus by the data transfer apparatus that stops a function of becoming a representative router for multicast data or lowers a priority for becoming a representative router for multicast data.

2. The data transfer apparatus according to claim 1, wherein, when stopping the function of becoming a representative router for multicast data, the data transfer apparatus executes at least one of processings of:
stopping transmission of one of a control message for a multicast routing protocol and a control message for a multicast terminal management protocol; and
transmitting one of a specific control message for a multicast routing protocol and a specific control message for a multicast terminal management protocol.

3. The data transfer apparatus according to claim 2, wherein the specific control message includes information indicating that the data transfer apparatus is to end being a representative for multicast routing or multicast terminal management.

4. The data transfer apparatus according to claim 1, wherein, when lowering the priority for becoming a representative router for multicast data, the data transfer apparatus of transmits a specific control message for a multicast routing protocol or a specific control message for a multicast terminal management protocol.

5. The data transfer apparatus according to claim 4, wherein the specific control message includes information indicating a lowered priority for becoming a representative for multicast routing or multicast terminal management.

6. The data transfer apparatus according to claim 1, wherein a trouble is detected in a network connected to the interface based on at least one of an electric trouble in the interface, a trouble of a unicast routing processing in the interface, or a trouble of a multicast routing processing in the interface.

7. The data transfer apparatus according to claim 1, wherein, when a trouble occurs in the network between the terminal for transmitting multicast data and the interface or the network between the terminal for receiving multicast data and the interface, the trouble is detected based on one of detection that at least one of other data transfer apparatuses, which are connected between a portion in which the trouble has occurred and the data transfer apparatus, has not transmitted a control message for a multicast routing protocol or a control message for a multicast terminal management protocol for a predetermined period, and detection that the at least one of other data transfer apparatuses has transmitted a specific control message for a multicast routing protocol or a specific control message for a multicast terminal management protocol.

8. The data transfer apparatus according to claim 1, wherein, when becoming a representative for multicast receiving terminal management by transmitting/receiving a control message for a multicast receiving terminal management protocol to/from the at least one of other data transfer apparatuses, the data transfer apparatus also becomes a representative for multicast routing.

9. The data transfer apparatus according to claim 1, wherein, when not becoming a representative for multicast receiving terminal management by transmitting/receiving a control message for a multicast receiving terminal management protocol to/from the at least one of other data transfer apparatuses, the data transfer apparatus does not become a representative for multicast routing.

10. The data transfer apparatus according to claim 8, wherein:
when the data transfer apparatus becomes the representative for multicast receiving terminal management and the representative for multicast routing, and when the data transfer apparatus receives a request to transmit multicast data based on a multicast terminal management protocol from the terminal for receiving multicast data, the data transfer apparatus:
transmits a request to transmit multicast data based on a multicast routing protocol from the interface; and
creates a multicast routing table for specifying a transfer route for multicast data.

11. The data transfer apparatus according to claim 8, wherein:
when the data transfer apparatus becomes the representative for multicast receiving terminal management and the representative for multicast routing, and when the data transfer apparatus receives a request to transmit multicast data based on a multicast terminal management protocol from the terminal for receiving multicast data, the data transfer apparatus:
transmits a request to stop multicast data based on a multicast routing protocol from the interface; and
deletes a multicast routing table for specifying a transfer route for multicast data.

12. The data transfer apparatus according to claim 1, wherein, when a trouble occurs in a network connected to the interface, a distribution route for multicast data is switched into a route passing the another multicast data transfer apparatus by the data transfer apparatus that stops a function as a representative for multicast receiving terminal management or transmits data including information indicating a lowered priority as a representative for multicast receiving terminal management.

13. The data transfer apparatus according to claim 1, wherein, when a trouble occurs in a network connected to the interface, a distribution route for multicast data is switched into a route passing the another multicast data transfer apparatus by the data transfer apparatus that stops a function as a representative for multicast routing or transmits data including information indicating a lowered priority as a representative for multicast routing.

14. The data transfer apparatus according to claim 1, wherein, when the data transfer apparatus becomes the representative for multicast receiving terminal management and the representative for multicast routing, and when a trouble occurs in a network connected to the interface, a distribution route for multicast data is switched into a route passing the another multicast data transfer apparatus by the data transfer apparatus that stops a function as a representative for multicast terminal management or transmits data including information indicating a lowered priority as a representative for multicast terminal management.

15. The data transfer apparatus according to claim 1, which is connected to further another data transfer apparatus for distributing multicast data to be transmitted to a terminal for receiving the multicast data from one of the data transfer apparatus and the another data transfer apparatus,
wherein, when a trouble occurs between the further another data transfer apparatus and the interface, a distribution route for multicast data is switched into a route passing the another multicast data transfer apparatus by the data transfer apparatus that stops a function as a representative for multicast routing or transmits data including information indicating a lowered priority as a representative for multicast routing.

16. A multicast system, comprising:
a terminal for transmitting multicast data;
a terminal for receiving multicast data; and
a plurality of data transfer apparatuses, capable of transferring multicast data, which are each connected to a link of a terminal for receiving multicast data and a terminal for transmitting multicast data,
the plurality of data transfer apparatuses each comprising:
an interface for transmitting/receiving multicast data; and
a transfer processing unit for performing a transfer processing on data received from the interface, wherein:
one data transfer apparatus is a data transfer apparatus to be a representative for a representative router for multicast data in the link of the terminal for receiving multicast data, and forms redundant topology with the other data transfer apparatuses; and
when a trouble occurs in a portion of a network made redundant between the terminal for transmitting multicast data and the interface of a data transfer apparatus to be the representative, a distribution route for multicast data is switched into a route passing the another multicast data transfer apparatus by the one data transfer apparatus that stops a function of becoming a representative router for multicast data in the link of the terminal for receiving multicast data or lowers a priority for becoming a representative router for multicast data.

17. A multicast system, comprising:
a terminal for transmitting multicast data;
a terminal for receiving multicast data;
a plurality of data transfer apparatuses, capable of transferring multicast data, which are each connected to a link of a terminal for transmitting multicast data and a terminal for receiving multicast data; and
another data transfer apparatus for transferring multicast data, which is connected between at least one of the plurality of data transfer apparatuses and the terminal for receiving multicast data,
the plurality of data transfer apparatuses and the another data transfer apparatus each comprising:
an interface for transmitting/receiving multicast data; and
a transfer processing unit for performing a transfer processing on data received from the interface, wherein:
one data transfer apparatus is a data transfer apparatus to be a representative for a representative router for multicast data in the link of the terminal for transmitting multicast data, and forms redundant topology with the other data transfer apparatuses; and
when a trouble occurs in a portion of a network made redundant between the another data transfer apparatus and the interface of a data transfer apparatus to be the representative, a distribution route for multicast data is switched into a route passing the another multicast data transfer apparatus by the one data transfer apparatus that stops a function of becoming a representative router for multicast data in the link of the terminal for receiving multicast data or lowers a priority for becoming a representative router for multicast data.

18. A program executable by a data transfer apparatus, capable of transferring multicast data, which is connected to a link of a terminal for receiving multicast data, a terminal for transmitting multicast data, and at least another data transfer apparatus made redundant, the program being capable of executing a multicast route switching method comprising the steps of:
detecting a trouble that occurs in a portion of a network made redundant with the terminal for transmitting multicast data; and
stopping, by the data transfer apparatus, a function of becoming a representative router for multicast data in the link of the terminal for receiving multicast data or lowering a priority for becoming a representative router for multicast data.

19. A program executable by a data transfer apparatus, capable of transferring multicast data, which is connected to a link of a terminal for transmitting multicast data, a terminal for receiving multicast data, and at least another data transfer apparatus made redundant, the program being capable of executing a multicast route switching method comprising the steps of:
detecting a trouble that occurs in a portion of a network made redundant with further another data transfer apparatus for transferring multicast data; and
stopping, by the data transfer apparatus, a function of becoming a representative router for multicast data in the link of the terminal for transmitting multicast data or lowering a priority for becoming a representative router for multicast data.
